(19) United States
(12) Patent Application Publication
(10) Pub. No.: US 2005/0154586 A1
(43) Pub. Date: Jul. 14, 2005

(54) Method of communication with speech-to-text transformation

(76) Inventor: Feng-Chi Liu, Chiayi City (TW)

Correspondence Address: RABIN & Berdo, PC, 1101 14TH STREET, NW, SUITE 500, WASHINGTON, DC, 20005, US

(21) Appl. No.: 11/030,169

(22) Filed: Jan. 7, 2005

(30) Foreign Application Priority Data
Jan. 13, 2004 (TW) 93100852

(51) Int. Cl. H04Q 7/20; H04M 1/00

(52) U.S. Cl. 704/235; 455/569.1

(57) ABSTRACT

A method of communication with speech-to-text transformation adaptable for a mobile communication system including a local mobile station, a system server, and a remote mobile station, is provided. The local mobile station communicates with the system server and sends a request for speech-to-text transformation to the system server. When the system server receives the request, three-party communication is formed among the system server, the local and remote mobile stations. The system server transforms the incoming voice from the remote mobile station into a text file, and sends the text file to the local mobile station via text messaging. The local mobile station displays the text file for the user to read. The user's outgoing voice can be transmitted to the other party via a receptor or a hand-free apparatus. Under three-party communication mode, the system server can send the outgoing voice to the remote mobile station directly.

This application claims the benefit of Taiwan application Serial No. 93100852, filed Jan. 13, 2004, the subject matter of which is incorporated herein by reference.

### BACKGROUND OF THE INVENTION

1. Field of the Invention

The invention relates in general to a method of communication with speech-to-text transformation, and more particularly to a method of communication with speech-to-text transformation facilitating those with auditory handicap to answer a mobile station.

2. Description of the Related Art

Along with the rapid advance in communication technology, the mobile station, which has gained a great popularity nowadays, further facilitates the convenience of communication between people. Despite that the majority of people would find the mobile station a convenient apparatus of communication, there are a few minorities of people still have not got much benefit from scientific and technological advance. For example, those with auditory handicap are among one of the minorities.

The mobile station has already had a diversity of functions such as text-messaging, audio/visual multi-media, recording, or even photographing. However, the design of mobile station totally neglects the fact that those with auditory handicap are unable to take the phone call like ordinary people. This negligence incapacitates those with auditory handicap of getting benefit from the convenience of mobile station. It is therefore necessary to develop a method of communication, which can be adapted to those with auditory handicap in a mobile communications system and enables them to enjoy high-quality communication service.

### SUMMARY OF THE INVENTION

It is therefore an object of the invention to provide a method of communication with speech-to-text transformation using a mobile station screen to display the content of a caller's voice in text in order for the user to read.

The invention achieves the above-identified object by providing a method of communication with speech-to-text transformation whose steps are disclosed below.

The method of communication with speech-to-text transformation is adaptable for a mobile communication system including a local mobile station, a system server, and a remote mobile station. On receiving a call from the remote mobile station, the local mobile station automatically communicates with the system server and sends a request for speech-to-text transformation of the incoming voice in the system server if the speech-to-text transformation function is already selected to be enabled. When the system server receives the request, three-party communication is formed among the system server, the remote mobile station, and the local mobile station. The system server then transforms the incoming voice from the remote mobile station into a text file and subsequently sends the text file to the local mobile station via text messaging, for example. The text is displayed to the user when received by the local mobile. By using a receptor or a hand-free apparatus, the user's outgoing voice can be transmitted to the other party. When receiving the outgoing voice under a three-party communication mode, the system server can send the incoming voice to the remote mobile station directly without executing speech-to-text transformation.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of a mobile station according to a preferred embodiment of the invention.

FIG. 2 shows a flowchart of a method of communication with speech-to-text transformation according to one embodiment of the invention.

### DETAILED DESCRIPTION OF THE INVENTION

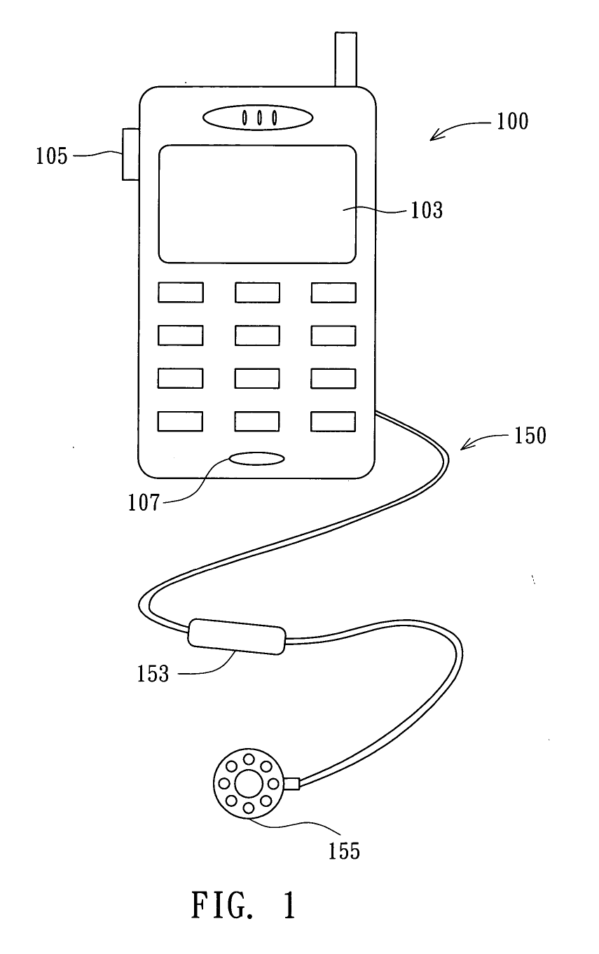

A three-party communication of a mobile communication system utilizes in the invention. When an incoming call from a remote mobile station is received by a local mobile station or when the local mobile station is connected to the remote mobile station, a system server of a telecom company transforms the incoming voice from the remote mobile station into a text file and transmits the text file to be displayed on the local mobile station in order for a person with auditory handicap to read. By doing so, the person with auditory handicap will be able to reply according to the incoming voice's content displayed on the mobile station. Referring to FIG. 1, a diagram of a mobile station according to a preferred embodiment of the invention is shown. The mobile station 100 has a screen 103, a function key 105, and a receptor 107 disposed thereon. The function key 105 provides the option regarding whether to enable the service of speech-to-text transformation, and can be an dedicated key or embodied by ways of a navigation key or a symbol key such as * or #. The screen 103 is for displaying the text file transmitted from the system server in order for the user to read. The receptor 107 is for receiving the user's outgoing voice. The mobile station 100 can also be incorporated with a hand-free apparatus 150 which includes a microphone 153 and a headset 155, wherein the microphone 153 receives the outgoing voice and has the same function with the receptor 107.

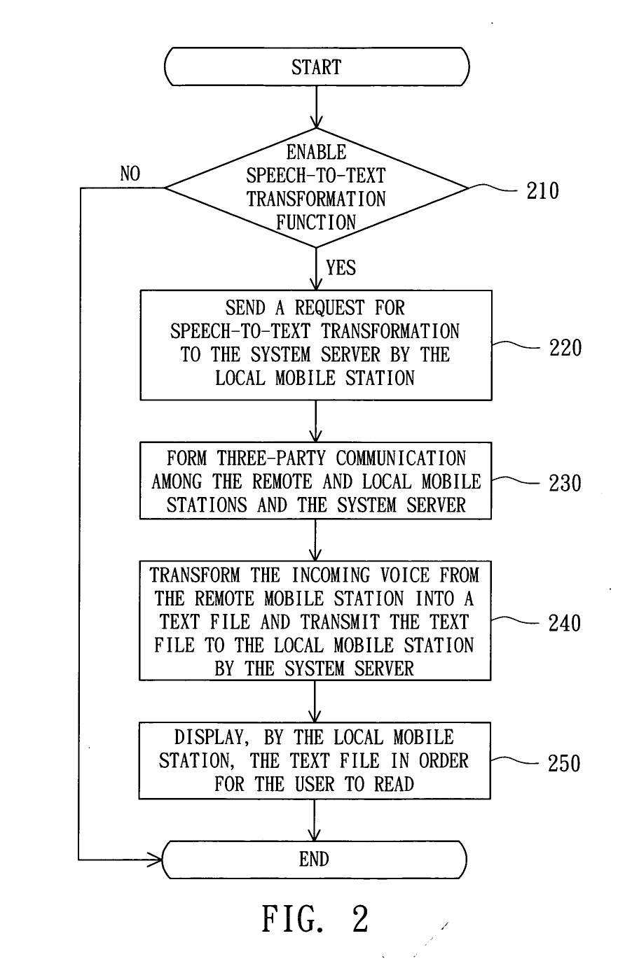

Referring to FIG. 2, a flowchart of a method of communication with speech-to-text transformation according to one embodiment of the invention is shown. The speech-to-text transformation function of the mobile station 100 can be enabled when the function key 105 is pressed. Meanwhile, if an incoming call from a remote mobile station arrives or the local mobile station communicates with the remote mobile station, the local mobile station automatically communicates with a system server to form three-party communication so as to transform the incoming voice into texts. The local mobile station will not send a request for speech-to-text transformation to the system server if the function key 105 is not pressed. For the sake of explanation, the mobile station used by the person with auditory handicap is called the “local mobile station”, while the mobile station used by another party of the communication is called the “remote mobile station”, wherein the two mobile stations are linked via a system server, forming a mobile communication system.

If the function key 105 has already been pressed (step 210, determined to be “yes”), the speech-to-text transformation function is enabled when the incoming call from the remote mobile station arrives or the local mobile station is linked to the remote mobile station. Meanwhile, the local mobile station automatically communicates with the system server and sends a request for a service of the system server for speech-to-text transformation to the system server, as indicated in step 220. When the system server receives the request from the local mobile station, three-party communication is formed among the system server, the remote mobile station, and the local mobile station (step 230). The system server transforms the incoming voice from the remote mobile station into a text file, and transmits the text file to the local mobile station. It is noteworthy that the transformation of the incoming voice can be done automatically by speech-to-text transformation software of the system server or can be done manually using manual transformation. After the speech-to-text transformation is done, the system server transmits the text file to the local mobile station via text messaging according to the telephone number of the local mobile station which is provided when speech-to-text transformation is requested (step 240). After receiving the text file, the local mobile station displays the text file on the screen in order for the user to read (step 250), receives the user's outgoing voice via a receptor or a microphone of a hand-free apparatus, and transmits the outgoing voice to another party of the conversation. Under the three-party communication mode, the system server receives the outgoing voice at the same time. However, the outgoing voice may not need to be transformed into text files, and the outgoing voice will be transmitted to the remote mobile station directly without speech-to-text transformation.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of communication with speech-to-text transformation for use in a mobile communication system, the mobile communication system comprising a system server, a local mobile station, and a remote mobile station, the remote mobile station communicating with the local mobile station via the system server, the method comprising the following steps:
sending, by the local mobile station, a request for speech-to-text transformation to the system server when the remote mobile station and the local mobile station are linked;
upon the system server receiving the request, forming three-party communication among the remote mobile station, the local mobile station, and the system server;
transforming, by the system server, an incoming voice from the remote mobile station into a text file, and transmitting the text file to the local mobile station; and
displaying the text file by the local mobile station.

2. The method according to claim 1, wherein the system server uses a speech recognition apparatus to transform the incoming voice into the text file.

3. The method according to claim 1, wherein the system server transforms the incoming voice into the text file by service staff.

4. The method according to claim 1, wherein the system server transmits the text file to the local mobile station via text messaging.

5. The method according to claim 4, wherein:
in said step of sending the request, the local mobile station provides a telephone number of the local mobile station when sending the request for speech-to-text transformation to the system server; and
in said step of transforming and transmitting, transmitting the text file to the local mobile station via text messaging according to the telephone number.

6. The method of according to claim 1, wherein the local mobile station is equipped with a function key for selectively enabling the local mobile station to send a request for speech-to-text transformation.

7. A method of communication with speech-to-text transformation for use in a mobile communication system, the mobile communication system comprising a system server, a local mobile station, and a remote mobile station, wherein the remote mobile station and the local mobile station are linked via the system server, the local mobile station is equipped with an external microphone and operated by a user, the method comprising the following steps:
sending, by the local mobile station, a request for speech-to-text transformation to the system server when the remote mobile station and the local mobile station are linked;
when the system server receives the request, forming three-party communication among the remote mobile station, the local mobile station, and the system server;
transforming, by the system server, an incoming voice from the remote mobile station into a text file, and transmitting the text file to the local mobile station; and
displaying the text file by the local mobile station in order for the user to read; and
receiving, by the local mobile station, an outgoing voice from the user via the external microphone, and transmitting the outgoing voice to the remote mobile station.

8. The method according to claim 7, wherein the system server uses a speech recognition apparatus to transform the incoming voice into the text file.

9. The method according to claim 7, wherein the system server transforms the incoming voice into the text file by service staff.

10. The method according to claim 7, wherein the system server transmits the text file to the local mobile station via text messaging.

11. The method according to claim 10, wherein:
in said step of sending the request, the local mobile station provides a telephone number of the local mobile station when sending the request for speech-to-text transformation to the system server; and
in said step of transforming and transmitting, transmitting the text file to the local mobile station via text messaging according to the telephone number.

12. The method according to claim 7, wherein the external microphone is disposed on a hand-free apparatus.

13. The method according to claim 7, wherein the local mobile station is equipped with a function key for selectively enabling the local mobile station to send a request for speech-to-text transformation.
